(19) United States
(12) Patent Application Publication
(10) Pub. No.: US 2015/0106702 A1
(43) Pub. Date: Apr. 16, 2015

(54) Cross-Lingual Input Method Editor

(71) Applicants: Matthew Robert Scott, Beijing (CN); Joseph K. Ngari, Seattle, WA (US); Joo-Young Lee, Redmond, WA (US); Weipeng Liu, Beijing (CN); Rongfeng Lai, Beijing (CN); Xi Chen, Beijing (CN); Huihua Hou, Beijing (CN)

(72) Inventors: Matthew Robert Scott, Beijing (CN); Joseph K. Ngari, Seattle, WA (US); Joo-Young Lee, Redmond, WA (US); Weipeng Liu, Beijing (CN); Rongfeng Lai, Beijing (CN); Xi Chen, Beijing (CN); Huihua Hou, Beijing (CN)

(73) Assignee: MICROSOFT CORPORATION, Redmond, WA (US)

(21) Appl. No.: 13/635,219

(22) PCT Filed: Jun. 29, 2012
(86) PCT No.: PCT/CN12/77896

§ 371 Date: Sep. 14, 2012

(51) Int. Cl. G06F 17/24; G06F 17/30

(52) U.S. Cl. CPC G06F 17/24; G06F 17/30696
USPC 715/265

(57) ABSTRACT

Some implementations provide techniques and arrangements for cross lingual candidate suggestion. For instance, some display a user interface of a host application including a text entry area. An input method editor (IME) receives one or more characters as input. In response, one or more completion candidates are displayed, at least one of the completion candidates being a cross lingual completion candidate in a language different from the one or more characters.

### CROSS REFERENCE TO RELATED APPLICATIONS

This application is a 35 U.S.C. 371 National Stage application of International Application No. PCT/CN2012/077896, filed Jun. 29, 2012, the entire contents of which are incorporated herein by reference.

### TECHNICAL FIELD

This disclosure relates to the technical field of computer input.

### BACKGROUND

The continued proliferation of computing devices has led to an increase in the availability of applications and other content used on these devices. For instance, users employ a variety of applications, such as games, digital media players, browsers, and the like, on an assortment of computing devices. As the number of computing devices and applications used on these devices continues to increase, users are ever more interested in enhancing their experiences while using these computing devices and applications.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Some implementations provide techniques and arrangements for cross lingual candidate suggestion. For example, some implementations display a user interface of a host application including a text entry area. An input method editor (IME) receives one or more characters as input. In response, one or more completion candidates are displayed, at least one of the completion candidates being a cross lingual completion candidate in a language different from the one or more characters.

### BRIEF DESCRIPTION OF THE DRAWINGS

The Detailed Description is described with reference to the accompanying figures. The use of the same reference numbers in different figures indicates similar or identical items.

FIG. 1 illustrates an example system according to some implementations.

FIG. 2 illustrates an example system according to some implementations.

FIG. 3 illustrates an example process flow according to some implementations.

FIG. 4 illustrates an example display according to some implementations.

FIG. 5 illustrates an example display according to some implementations.

FIG. 6 illustrates an example system according to some implementations.

FIG. 7 illustrates an example process flow according to some implementations.

FIG. 8 illustrates an example process flow according to some implementations.

FIG. 9 illustrates an example display according to some implementations.

FIG. 10 illustrates an example display according to some implementations.

FIG. 11 illustrates an example system in which some implementations may operate.

### DETAILED DESCRIPTION

### Overview

This disclosure includes techniques and arrangements for cross lingual input methods, and in some implementations, for a cross lingual input method editor (IME) that provides completion candidates to a user for insertion into a computer application. In some implementations, the cross lingual IME provides completion candidates based, at least in part, on contextual information related to the user input.

In some implementations that involve an IME, the system assists a user in entering text in a first language by allowing the user to enter a corresponding text in a second language and then providing suggested candidates in the first language for insertion into a computer application. Consider the following scenario. A user is entering text into an IME in Spanish, but the user's first language is English. In such a scenario, the user may have difficulty thinking of the appropriate Spanish term, but know the appropriate English term. Some implementations provide assistance to the user by enabling the user to input the appropriate English term to the IME, then present the user with a list of suggested Spanish candidate terms for selection by the user and insertion into a host program by the IME.

Other implementations may not involve an IME, but rather perform cross lingual assisted functionality in other programs such as a spell checking function in a word processor program, an autocomplete function of applications such as a text messaging program of a mobile computing device, a character/word recognition functionality of handwriting recognition applications, and word recognition functionality of voice recognition/dictation applications. This list is not meant to be exhaustive and example implementations are merely examples which are not to be taken as limiting. Thus, it should be understood that, though this disclosure may, for ease of understanding, describe the system and method in the context of an IME, the system and method described herein are not limited to such uses and may be used in many other situations.

The cross lingual assistance functionality described herein may be implemented at various levels in the software and hardware of computing systems. Such levels include the Operating System (OS) level, such as in the OS with or without application support, the application level, either separate from the OS (i.e. stand-alone) or as a plug-in to the OS or a plug-in to another application and so forth. Further, the cross lingual assistance functionality may be implemented universally for all text entry areas in all applications, such as in OS only implementations, or the functionality may only be active in select text entry areas, either in specific programs (e.g. a OS level IME), classes of programs (e.g. dedicated IMEs of individual programs), specified text entry areas, classes of text entry areas, and so forth. Moreover, some implementations may allow a user to set various parameters of the cross lingual assistance functionality such as, the class of programs or text entry areas that implement the functionality, the languages and writing systems to be used for the functionality and so forth.

As stated above, an input method editor (IME) is a computer application that assists a user to input text to a computing device. An IME may provide several completion candidates based on inputs received from the user. In some implementations of a cross lingual IME described herein, the input text and the provided candidate texts may be in the same language and/or writing system or different languages and/or writing systems or some combination thereof.

For example, the user may input one or more initial Latin characters of an English word or phrase and an IME, based on the initial characters, provides one or more complete English words or phrases from which the user is able to select a proper one. Such a function is referred to as an autocomplete function or may be referred to as a same language completion candidate suggestion. In some implementations, the autocomplete functionality may be implemented as a client-side binary-search-based data structure.

In another example, an IME may also assist the user to input non-Latin characters such as East Asian characters (e.g. Hanzi) through transliteration. This function of an IME may allow a user to input non-Latin characters in popular operating systems whose keyboards usually only support inputting Latin characters. For example, the user may input Latin characters through a keyboard to form a phonetic spelling of a Chinese Hanzi character. The IME returns one or more Chinese characters based on the spelling to the user to select a proper one. One such phonetic writing system for Chinese is Pinyin, which can be properly described as a transliteration of Chinese into Latin characters (also referred to as a Romanization of Chinese).

In a further example, an IME combines the transliteration function just described with a translational function to assist a user writing in a first language when the user is unable to recall the appropriate term in that first language but can recall the corresponding word in the non-Latin character writing system of a second language. This is similar to the English and Spanish example provided. However, in this case, using Chinese as an example, the IME performs recognition of the Pinyin term, determines candidate transliterations of the Pinyin term into Chinese Hanzi characters, determines English translations of the candidate Hanzi terms, and then provides user with the candidate Hanzi terms and their corresponding English equivalents. The user then selects a chosen candidate term. The English equivalent completion candidate selected by the user may then be inserted into various other computer applications, such as a chatting application, a document editing application, a gaming application, etc.

In some implementations, a listing of completion candidates could include both same language completion candidate and cross language completion candidates.

In discussions involving two languages, the discussion herein may use specific languages for ease of comprehension. For example, several figures use English and Chinese as examples while another uses English and Spanish. In such discussions, the examples may be generalized to any first language and second language. Specifically, English may be generalized in these discussions to any first language and Chinese and Spanish may be generalized to refer to any second language.

### Example Implementations

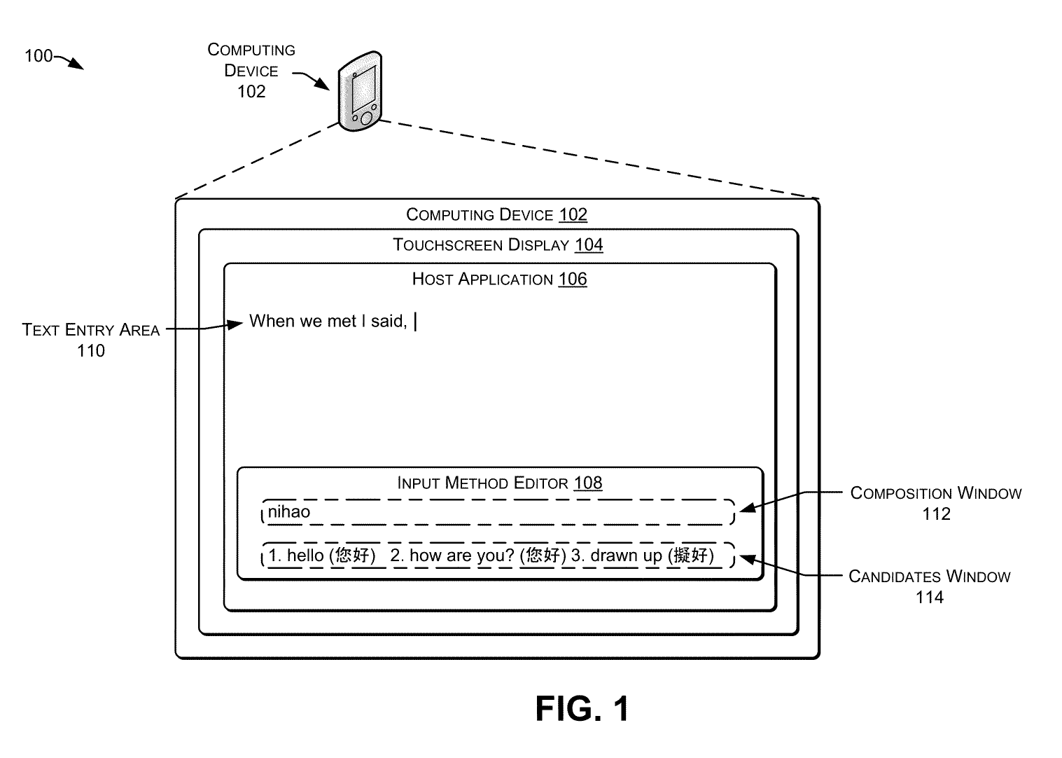

FIG. 1 illustrates an example framework of a system 100 according to some implementations. System 100 includes a computing device 102 that is illustrated as a logical system made up of a touchscreen display 104 which is currently displaying a host application 106 and an input method editor 108. The host application includes a text entry area 110 and the input method editor (IME) 108 includes a composition window 112 and a candidates window 114. Though not shown in FIG. 1, in some implementations, the computing device 102 includes one or more processors and memory wherein the memory includes the program instructions of the host application 106 and IME 108. However, other implementations are not limited to such an arrangement. As mentioned above, while this example implementation uses English and Chinese for ease of comprehension, any first and second language could be substituted as appropriate to any particular implementation.

In the example shown in FIG. 1, a user has used the composition window 112 of the IME 108 to input “When we met I said,” to the host application. In some example embodiments, the user may have used an onscreen keyboard (not shown) in conjunction with touchscreen display 104. Having entered the aforementioned phrase, the user then, possibly unable to recall the appropriate English word, enters “nihao” to the IME 108. In response to a determination that “nihao” forms or partially forms a Pinyin term, the computing device 102 makes the aforementioned transliteration and translation to determine and cause the IME 108 to present the user with three suggested English completion candidates for “nihao” in the candidates window 114 (i.e., “hello,” “how are you?,” and “drawn up”).

In some implementations, such as the one shown in FIG. 1, the IME 108 also includes, in parenthesis, a Hanzi equivalent of each of the English candidates. The inclusion of the Chinese Hanzi equivalent may be due to any of a variety of reasons. Two possible reasons are: 1) there is not a one-to-one relationship between Pinyin and Hanzi and 2) the inclusion of the Hanzi equivalent may provide the user with more confidence and/or increase the accuracy of the user's selection. In some implementations, the Hanzi characters may be visually set off from the English terms by means of italics or a different font color. This visual set off may serve as an indicator that the Hanzi characters are for reference and will not be included in the text inserted to the host application 106. Though specific visual setoffs are shown and discussed, implementations are not limited to any particular visual setoff or even to the use of any visual set off.

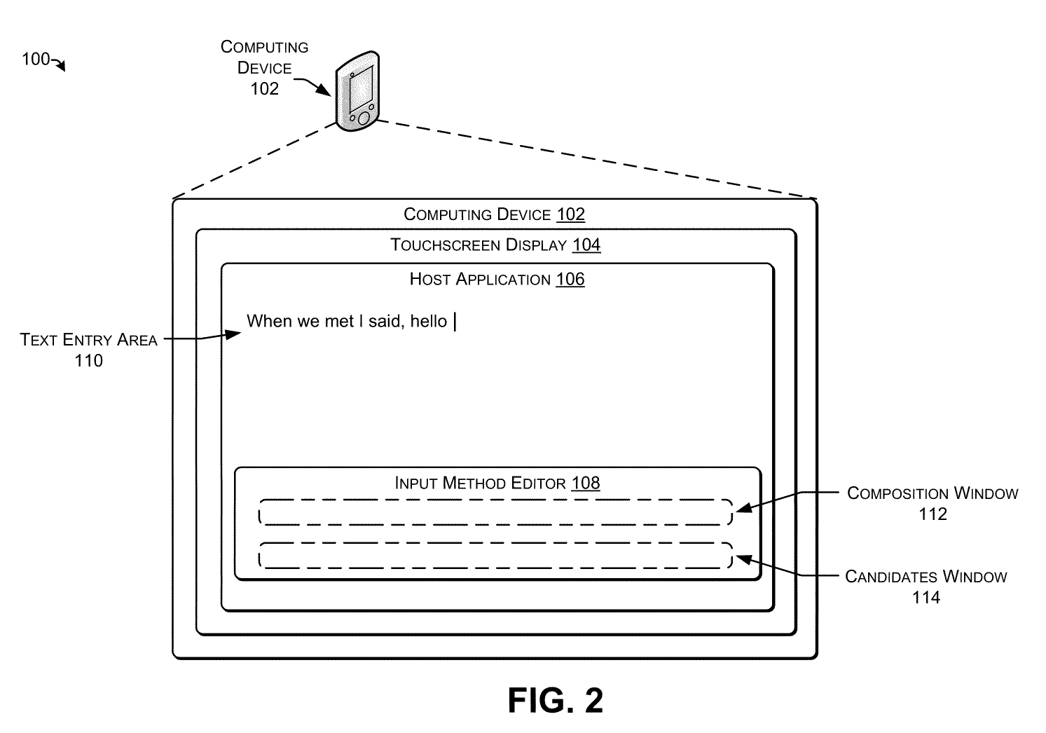

FIG. 2 illustrates the example framework of system 100 following a user's selection of item one, “hello,” from the candidates window 114 of the input method editor (IME) 108. Specifically, upon receiving the selection, the IME 108 caused the term “hello” to be inserted into the text entry area 110 of the host application 106 at the insertion point cursor symbol shown in FIG. 1. After or concurrent with inserting the selected candidate into the host application 106, the IME 108 clears or resets the composition window 112 and candidates window 114 for continued entry of text.

For ease of discussion and comprehension, FIGS. 1 and 2 are illustrated as including a touchscreen display 104 for which entry of text is generally accomplished by touch selection of an on-screen keyboard. However, implementations are not so limited. The user input may be accomplished through a variety of input methods such as a keyboard input, a voice input, and a touch screen gestural input (e.g. handwriting recognition). For example, in some implementations, the computing device 102 may include a mouse and keyboard and the input of text is done by typing on the keyboard or using by an on screen keyboard with the mouse. Selection of completion candidates in such an implementation could be by input of a numeric identifier (e.g. inputting a “1” to select “hello” in FIG. 1) or by mouse input (e.g. clicking on “hello” in the candidates window 114). In another example implementation, a system with voice input, (e.g. dictation software) may allow a user dictating in English, who reaches an English term which the user cannot recall, to speak the Chinese equivalent of the English term which the user cannot recall. The spoken term could be recognized as being a non-English term, at which point the system may present English language completion candidates and their Hanzi equivalents for the user's selection as discussed above regarding FIG. 1. These and other variations on the implementation of the particulars of the input methods usable with the disclosed techniques and arrangements would be apparent to one of ordinary skill in the art in view of the disclosure herein.

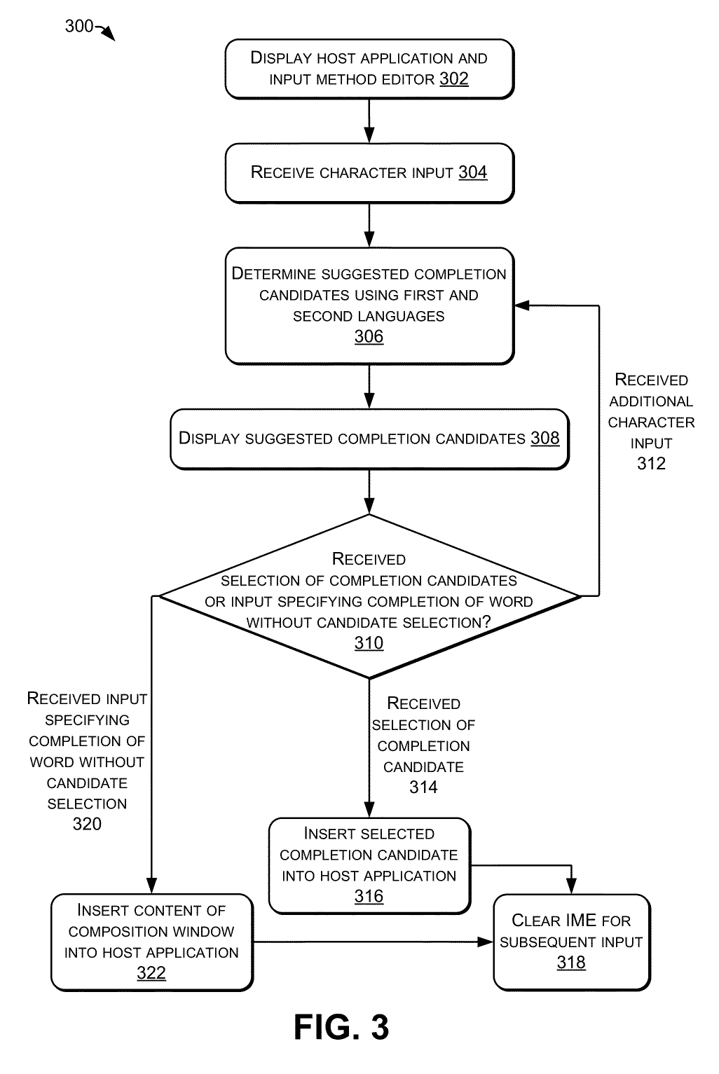

FIG. 3 illustrates an example process flow 300 according to some implementations. In the flow diagrams of FIG. 3, each block represents one or more operations that can be implemented in hardware, software, or a combination thereof. In the context of software, the blocks represent computer-executable instructions that, when executed by one or more processors, cause the processors to perform the recited operations. Generally, computer-executable instructions include routines, programs, objects, modules, components, data structures, and the like that perform particular functions or implement particular abstract data types. The order in which the blocks are described is not intended to be construed as a limitation, and any number of the described operations can be combined in any order and/or in parallel to implement the processes. For discussion purposes, the process 300 is described with reference to the system 100, described above, although other models, frameworks, systems and environments may implement the illustrated process.

At block 302, the computing device 102 displays the host application 106 and input method editor (IME) 108 on the touchscreen display 104.

At block 304, the computing device 102 receives a character input. As discussed above, implementations of the techniques and arrangements disclosed herein may utilize a wide variety of input methods and devices. However, for brevity, the discussion of FIGS. 3-5 and 9-10 will discuss input in the context of touch input to an on-screen keyboard displayed and actuated using touchscreen display 104.

At block 306, the IME 108 analyzes the received character input and, based thereon, determines suggested completion candidates in a first language and a second language, English and Chinese respectively. It should be noted that the IME 108 may take other information into consideration in its determination. Some examples of other information will be discussed below. The process flow then continues to block 308.

At block 308, IME 108 displays any suggested completion candidates in the candidates window 114. The flow then proceeds to block 310.

At block 310, the IME 108 awaits one of three events. First, if the IME 108 receives an entry of one or more additional characters 312 (other than a character input selecting a candidate term to be inserted), the flow returns to block 306 and a new determination of suggested completion candidates is performed.

Second, if at block 310, the IME 108 receives a selection of a suggested completion candidate 314 for insertion into the host application 106, the flow moves to block 316. At block 316, the selected completion candidate is inserted into the text entry area 110 of the host application 106 in a manner that may be similar to that discussed above regarding the insertion of the word “hello” into the host application 106 and shown in FIG. 2. The flow then proceeds to block 318.

Third, if at block 310, the IME 108 receives an input specifying the completion of a word without the use of a completion candidate 320 (e.g., an instruction to insert a space or the like to indicating a shift to a new word), the flow moves to block 322. At block 322, the contents of the composition window 112 is inserted into the text entry area 110 of the host application 106. As an example, such a situation may occur when the user wishes to insert a non-English term into the text. The flow then moves to block 318.

At block 318, either a suggested completion candidate or the contents of the composition window 112 has been inserted into the text entry area 110 of the host application 106 by the IME 108. The IME 108 then clears the composition window 112 and the candidates window 114, such that the IME is prepared for subsequent input. Though not shown, the process flow 300 could then move back to block 304 upon receiving a further character input.

As mentioned above, the IME 108 may take into account information in addition to the received character input in determining suggested completion candidates. In some implementations, this additional information includes contextual information. Two example types of contextual information that may be used are N-grams and scenario information. An example of an N-gram is a sequence of N words to the left of the cursor and M words to the right of the cursor. An example of scenario information is information that includes items such as the process name, input scope (field type/name), version of the application, and version of the operating system. In some implementations, the received character input (i.e. the contents of the composition window 112) may be used to generate any number of completion candidates that could be displayed in the candidates window 114. The contextual information, such as N-grams and scenario information may be used in some implementations to rank the generated completion candidates for display to the user. In cases in which the number of completion candidates generated is larger than the number that can be displayed in the candidates window, the additional information may be used to select which completion candidates will be displayed.

In some implementations, N-grams may be useful at the content level of the document, and scenario information may provide information about the document itself and environmental context.

With N-grams, the system may detect distinct “trigger words” like “said” that co-occur highly with a translated Chinese equivalent, as seen statistically, for example, on the web, with words like “hello.” Consequently, in implementations that include N-gram information, a candidate term may appear higher on the candidate ranking list if the nearby text of the N-gram contains a trigger term associated with that candidate. The discovery of trigger words and their corresponding collocated terms is a computational linguistic method called “collocation extraction.” Generalizing this, some implementations may build a language model, which is then employed to probabilistically affect the ranking of candidates based on context. Implementations may also apply the N-gram analysis in a cross lingual context such that the context is analyzed between terms written in a different languages, and further, in non-Latin writing systems of such languages, the analysis is performed between a transliteration of a language with term of another language.

Scenario information may be used as another feature in the ranking. In some implementations, the IME 108 uses the input scope and application name to provide a signal implying different styles of writing. For example, the writing style which one may employ when conversing with their manager in an email within Microsoft Outlook® might be different from the writing style one uses to communicates with a family member on Windows Live Messenger, Hotmail or Gmail. As an example, the scenario information might include the information that the input scope is an email message body and the application name is Outlook.

An example of this analysis can be seen in FIG. 1 where the term “nihao,” or more specifically, its translation, “hello,” may be analyzed using n-grams and scenario information. To reach the point shown in FIG. 1, where “hello” was ranked as the first candidate, the computing device 102 uses the aforementioned contextual information to promote the term “hello.” That is, the IME 108 observes that 1) the trigger term “said,” which is a known collocation of “hello,” occurs immediately prior to the current insertion point, 2) the input scope is that of a document and the application is Microsoft Word®, which would both imply a more formal writing style, where again “hello” would be higher on a candidate list. In view of this contextual analysis, “hello” is ranked as the first candidate (unless another term is given a higher “relevance score”).

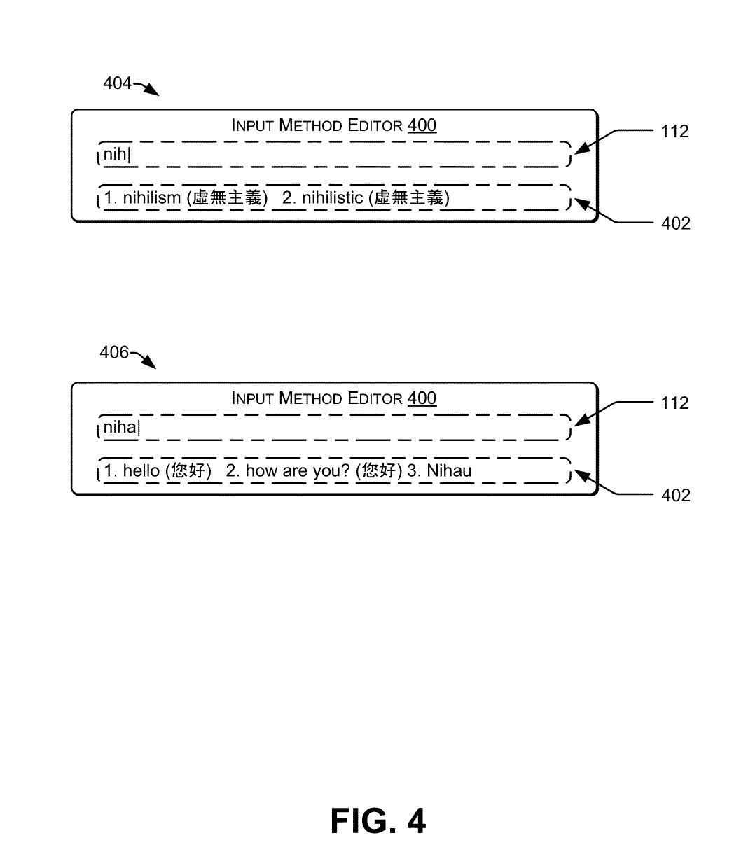

FIG. 4 illustrates the function of an input method editor (IME) 400. IME 400 is similar to the input method editor 108, but includes some variations in its functionality and includes a different candidates window 402 from that of IME 108. FIG. 4 illustrates examples of the suggested candidates of the input method editor (IME) 400 in two states one in which “nih” has been entered into the composition window at item 404 and another in which “niha” has been entered into the composition window at item 406. As noted above, the functionality of the input method editor 400 differs from the functionality described above for IME 108. Two variations are discussed below.

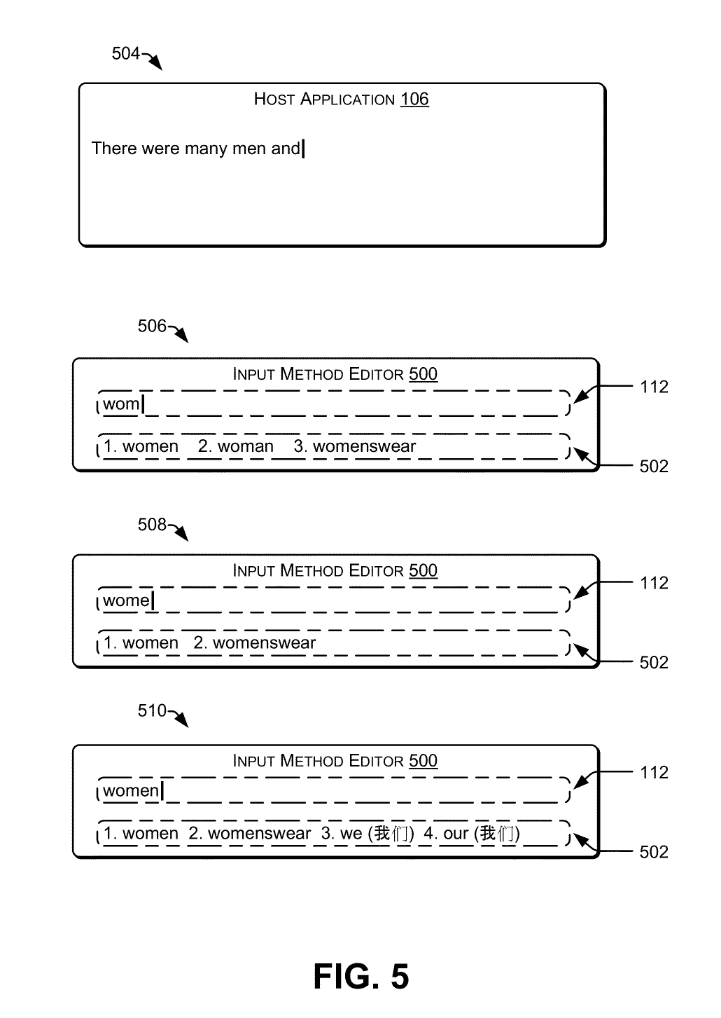

The first variation can be seen in the candidates window 402 of the IME 400 in item 404. Specifically, the IME 400 has provided completion candidates that are direct English-to-English completions in item 404, but nonetheless shows the Hanzi characters of the corresponding Chinese words next to the suggested completion candidates. This illustrates that the display of the Hanzi characters in the candidates window 402 may be, but is not required to be limited to cross lingual candidate suggestions such as those discussed with regard to FIG. 1. An implementation in which only cross lingual completion candidates include Hanzi equivalents appears in FIG. 5 discussed blow. Depending on the implementation, this difference may be the result of IME 400 being specifically designed to always show Hanzi characters for any English language suggested completion candidate included in the candidates window 402, or IME 400 may include adjustable user settings to allow the user to enable, disable, or customize when such Hanzi equivalents are included in the candidates window 402. It should again be noted that references to English could be modified to any other first language and references to Chinese and Hanzi could be modified to any other second language as appropriate.

The second variation is that IME 400 of the implementation shown in FIG. 4 does not always execute the cross lingual candidate suggestion functionality. Rather, IME 400 executes the cross lingual candidate suggestion functionality when the IME 400 determines that one or more conditions are met. In the example shown in FIG. 4, the IME 400 determines whether three conditions are met. The first condition that IME 400 checks is whether a language mode of the IME 400 is or has changed to a “foreign input mode” (e.g. “English mode”). In some implementations, the input mode is switched in and out of “foreign input mode” when the user presses the, for example, Shift key or uses a menu option within the user interface. Except as otherwise stated, it is assumed for the discussion herein that the user has entered the “foreign language mode” throughout each process. The remaining two conditions are discussed with respect to item 404 below.

At item 404, a user has entered “When we met I said, nih” to the composition window of the input method editor 108. The phrase “When we met I said,” has been inserted into the host application in a manner such as that shown in FIG. 1. The IME 400 processed the entered characters and, returned two English words, “nihilism” and “nihilistic,” as completion candidates. As mentioned above, in some implementations, the IME may not perform cross lingual candidate suggestion due to one or more conditions. Specifically, some implementations, such as the one shown in FIG. 4, may perform cross lingual candidate suggestion when a character count in the composition window is greater than a number of characters N but less than a number of characters M. In an example implementation, N maybe >=4 and M may be <=16. In some such implementations, this may be done because, with fewer than 4 characters, it may be less likely that the word is formed enough, and with more than 16 characters, the input becomes more sentence-based machine translation which may be less accurate. In addition to, or as an alternative to, checking a condition on the character count, an IME may determine a number of candidates in the first language (here, English) that will be available and, if the number of candidates is greater or equal to a number K, the IME 400 may forego cross lingual candidate suggestion. On the other hand, when the number of candidates in the candidates window is less than K, the IME 400 performs cross lingual candidate suggestion. As an example, in some implementations, where the maximum number of candidates that can be shown is five, K might be <=3. In general, some implementations may be designed based on the assumption that, if the IME can produce a full listing of autocomplete suggestions (i.e. same language completion candidates) for the given input then, it is likely the user did not enter a term in the second language (or a transliteration of a term in the second language).

At 404, the user has now input “niha” to the composition window of the input method editor 400. At this point, the number of characters is greater than four (the example discussed above) and the number of English language words having this beginning is limited to one proper Noun name of a city “Nihau.” Thus, in item 404, the IME 400 determines that cross lingual candidate suggestion should be performed. As a result of the cross lingual candidate suggestion analysis, the IME 400 determines that “nihao” is a possible Pinyin completion of “niha.” Next, the IME 400 performs the context analysis discussed above, including the collocation determination. From this, it is determined that, of the Hanzi terms corresponding to the Pinyin word “nihao,” the term that translates into English as “hello” or “how are you?” is the highest ranked. It then determines that the English equivalent “hello” has a higher statistical probability of being chosen based at least in part on the collocation of “said” with “hello.” In the example implementation shown in FIG. 4, from the point of view of being included in the candidates window, priority is maintained for same language completion candidates. In other words, though other cross lingual completion candidates may have higher contextual analysis “scores,” the same language completion candidate “Nihau” is given priority in selecting which completion candidates to include in the candidates window 402. However, this priority does not extend to the ranking. In short, some implementations rank the translational equivalents against the term “Nihau” using a statistical model that leverages contextual information such as that discussed above. Because Nihau is determined to have a lower contextual “score,” “hello” and “how are you?” are given higher ranks and presented higher in the candidates window 402 shown in item 406.

For brevity, it should be understood that this ranking process, or one similar thereto, may be applied to the completion candidates in any given implementation to determine which candidate terms will be presented in the candidates window and the order which completion candidates will be presented. Thus, unless stated otherwise, it should be assumed that similar processes described in this specification may also implement such a ranking/selection technique, but this is not to be taken as a limitation.

Following the state illustrated at 406, should the user finish inputting the term “nihao” into the composition window 402, the IME 400 will mirror the appearance of IME 108 in FIG. 1 because no further same language completion candidates are available.

FIG. 5 illustrates the function of an input method editor (IME) 500. IME 500 is similar to IME 108 and IME 400 but has some variations in its functionality and includes a different candidates window 502 from that of IME 108 and IME 400. Text entered to the IME 500 is inserted to the host application 106 indicated as item 504. Prior to the states 506, 508, and 510 of the IME 500 shown in the FIG. 5, and particularly prior to state 506, the phrase, “There were many men and” has been entered to the IME 500 and the IME 500 has inserted the phrase into the host application 106. FIG. 5 illustrates examples of the suggested candidates of the IME 500 when 1) at item 504, “wom” is then entered into the composition window, 2) at item 508, “e” is entered such that the composition window at item 508 includes the characters “wome” and 3) at item 510, “n” is entered such that the composition window at item 510 includes the characters “women.” As noted above, the functionality of the input method editor 500 differs from to the functionality described above for IME 108 and IME 400 as described below.

At item 506, the IME 500 receives the input characters “wom,” processes the entered characters and, returns the English words, “women,” “woman,” and “womenswear.” Unlike IME 400, which included the Hanzi equivalent of any English term shown in the candidates window 402, IME 500 does not show Hanzi equivalents of same language completion candidates (i.e. direct English to English candidates). For example, at 506, the English terms “women,” “woman” and “womenswear” are not accompanied by their Hanzi equivalents as they are same language completion candidates proposed based on an English use of the root “wom.” The lack of Hanzi equivalents for same language completion candidates may be due to a variety of factors such as the IME 500 being designed to not include equivalents for same language completion candidates or the IME 500 may have a user setting that allows the display of the Hanzi equivalents for same language completion candidates to be enabled or disabled.

Further, in the implementation shown in FIG. 5, at 506, the IME 500 does not perform the cross lingual candidate suggestion function because the outcome of the character count condition determination is the same as that discussed above with respect to item 404. Specifically, less than four characters have been entered into the IME 500 at 506. However, another variation in the function of IME 500 would have narrowed the scope of the performance of the cross lingual candidate suggestion function even had four characters been entered. This is discussed with regard to item 508 below.

At item 508, the IME 500 receives input of the character, “e,” processes the text in the composition window 112 (i.e. “wome”), and returns two English words, “women” and “woman.” As mentioned to above, in the example implementation illustrated in FIG. 5, though the composition window contains at least 4 characters and there are not more than three English candidates, no cross lingual candidates have been included in the candidates window 502. This is because in the implementation illustrated in FIG. 5, IME 500 has a reduced cross lingual candidate completion scope from which to suggest candidates. In particular, IME 500 performs only cross lingual checks based on the contents of the composition window for complete Pinyin terms. Thus, while women is both the spelling an English word and the transliteration of the Chinese word for “we” or “our,” IME 500 restricts the cross matching to the character string “wome” which does not have a Chinese equivalent in Pinyin.

At item 510, the IME 500 receives input of the character “n,” processes the text in the composition window 112 (i.e. “women”), and returns two English words, “women” and “woman.” During the processing of the term “women,” the IME 500 also determines that “women” is a transliteration of at least one Chinese word. Accordingly, the IME 500 obtains information regarding cross lingual completion candidates for the pinyin-Chinese term “women” for possible display in the candidates window 502. In some implementations, the IME 500 determines that the English terms, “we,” “our,” and “ourselves” are each possible translations of the pinyin transliteration “women.” The IME 500 performs ranking/selection on these terms as well as the English completion suggestions “women” and “womenswear” to obtain and present the list shown in candidates window 502 at item 510. In the non-limiting implementation shown at 510, the term “women” is ranked at the top of the list due to its common collocation with the words/phrase “men and” as part of the phrase “men and women.” Womenswear, while not having a contextual “score” as high as women, is found to have a higher score than “we” and “our.” The rankings continue down the list. This results in the lowest ranked completion candidate, “ourselves,” not being shown in the candidates window 502 due to it not fitting within the available space.

Following the state illustrated at 510, the user may continue by selecting one of the candidates for insertion, inputting an appropriate command to insert the contents of the composition window without regard to any of the suggested completion candidates, or by entering a further character.

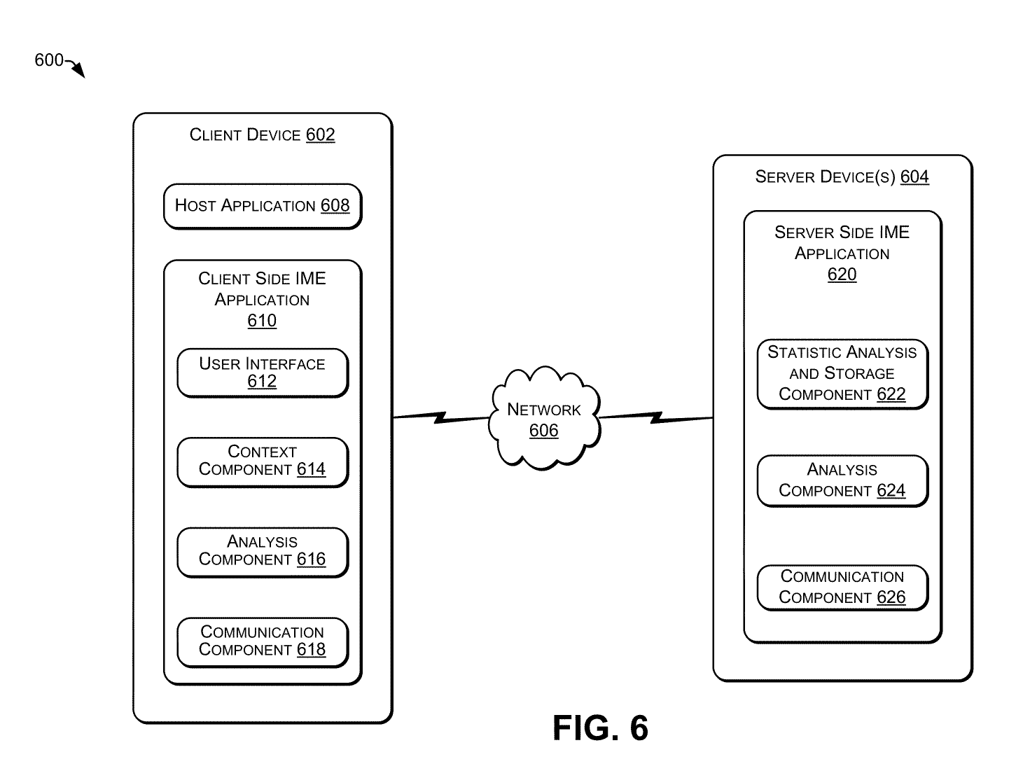

FIG. 6 illustrates a logical framework 600 of an alternative implementation which includes a client device 602 and one or more server devices 604. The client device 602 and the one or more server devices 604 communicate across a network 606 to perform completion candidate suggestion similar to that discussed above regarding FIGS. 1-5. Further, although the server devices 604 are shown as a single entity, it should be understood that some implementations include many individual server devices. For example, some implementations may implement the server devices 604 “in the cloud” due to abundant memory and processing power available in such an arrangement.

The client device 602 includes a host application 608 and a client side input method editor (IME) application 610. The client side IME application 610 includes a user interface 612, a context component 614, an analysis component 616, and a presentation component.

The host application 608 is similar to the host application 106 discussed above with regard to FIGS. 1-5. The user interface 612 of the client side IME application 610 receives input from the user and displays the suggested text candidates to the user in a graphical user interface (GUI), similar to the GUIs shown in FIGS. 1, 2, 5, 9, and 10. The user interface 612 also receives other user inputs and/or commands such as an input selecting a completion candidate for insertion into the host application 608. The context component 614 collects data relating to the context of the user input. The analysis component 616 analyzes user input based at least in part on the collected context data and determines any suggested completion candidates in a first language based on received input. The analysis component 616 then determines whether the one or more server devices 604 should be queried regarding additional information, such as cross lingual completion candidates based on a second language as well as, depending on the particular implementation, selection of the completion candidates to be presented and the order for presentation. The communication component 618 conducts communication between the components of the client device 602 with other devices, such as the one or more server devices 604, across network 606.

Some modules of the client side IME application 610 may be implemented as separate systems and their processing results can be used by the IME 610. For the sake of convenient description, the above IME is functionally divided into various modules which are separately described. When implementing the disclosed system, the functions of various modules may be implemented in one or more instances of software and/or hardware.

The one or more server devices 604 may each include a server side input method editor application 620. The server side IME application 620 includes a statistic analysis and storage component 622, an analysis component 624, and a communication component 626.

The statistic analysis and storage component 622 creates and maintains statistical information, index tables of transliterations and translations, and other pieces of information to be used by the one or more server devices 604 to answer queries from the client device 602.

The analysis component 624 uses the received characters and context information in queries from client devices, as well as information stored by the statistic analysis and storage component 622 to determine cross lingual completion candidates based on a second language as well as, depending on the particular implementation, completion candidates in the first language. The analysis component 624 may also select the terms to be presented as completion candidates and the order for their presentation using a ranking technique, such as the technique described above with respect to FIGS. 4 and 5.

The communication component 626 conducts communication between the components of the one or more server devices 604 with other devices, such as the client device 602, across network 606.

There may be other configurations of an IME system in a client-server architecture. In another example, the analysis component 616 may be located in the one or more server device(s) instead of the client device 110. In yet another example, the analysis component 624 of the one or more server devices 604 may be incorporated into the client device 602.

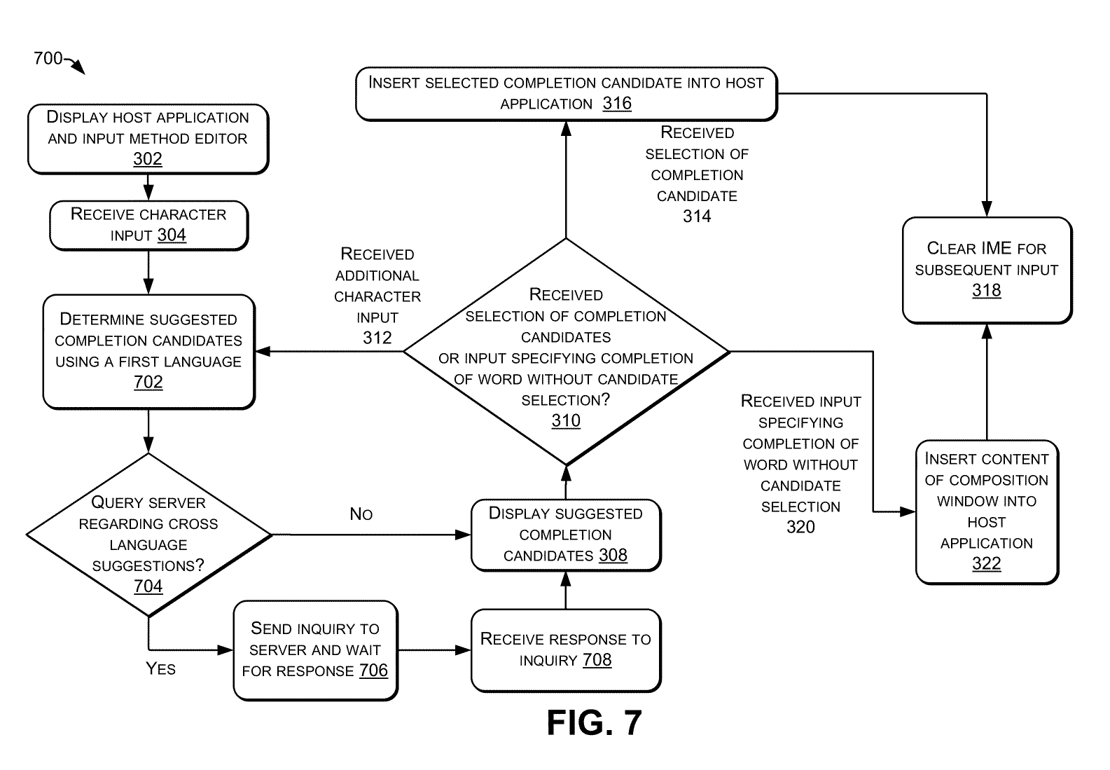

FIG. 7 illustrates an example process flow 700 according to some implementations. For discussion purposes, the process 700 is described with reference to the framework 600, and particularly the client device 602, described above, although other models, frameworks, systems and environments may implement the illustrated process.

At block 302, the user interface 612 of the client side input method editor application 610 causes a graphical user interface (GUI) of the client side input method editor (IME) 610 to be displayed, for example, over the host application 608 on a touchscreen display such as touch screen display 104. At block 304, user interface 612 of the client device 602 receives a character input.

At block 702, the context component 614 collects data relating to the context of the received character input. The analysis component 616 analyzes received character input and determines any suggested completion candidates in a first language based on received input. The flow then proceeds to block 704.

At block 704, the analysis component 616 determines whether to query the one or more server devices 604 regarding suggested completion candidates based on a second language. If the analysis component 616 determines that the server should not be queried, the process flow then continues to block 308. If the analysis component 616 determines that the server should be queried, the process flow then continues to block 706.

At block 706, the communication component 618 send an inquiry to the one or more servers 604. The inquiry includes information such as the received input characters, the contextual information, etc. Depending on the particular implementation, information in addition to suggested completion candidates based on a second language may be queried as well. For example, the inquiry could request a selection of the suggested completion candidates to be presented and the order for presentation. The flow then proceeds to block 708.

At block 708, the communication component 618 receives a response to the inquiry from the one or more servers 604. The flow then proceeds to block 308.

The operation of blocks 308-318 shown in FIG. 7 is the same as was previously discussed regarding FIG. 3. Accordingly, the discussion of the operation of these blocks is not repeated here.

Once the flow reaches block 318, either a suggested completion candidate or the contents of the composition window 112 has been inserted into the host application 608 by the client side IME application 610. The client side IME application 610 then clears its composition window and candidates window, such that the client side IME is prepared for subsequent input. Though not shown, the process flow 700 could then move back to block 302 of FIG. 7 upon receiving a further character input.

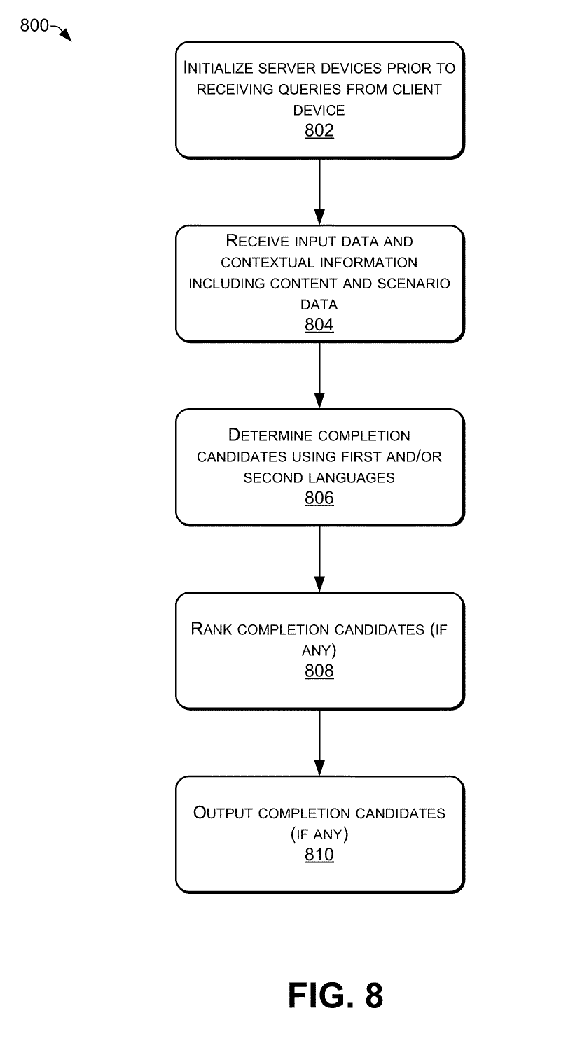

FIG. 8 illustrates an example process flow 800 according to some implementations. For discussion purposes, process 800 is described with reference to the framework 600, and particularly the one or more server devices 604, described above, although other models, frameworks, systems and environments may implement the illustrated process.

At block 802, the one or more server devices 604 are initialized. Because, in the example implementation shown in FIG. 8, the server devices determine results for queries from the client device 602 based on large index tables of transliterations and translations that are generated before receiving the requests, at initialization, the one or more server devices 604 create, update, and load the information into memory.

In some implementations, this allows the server devices 604 to utilize large quantities of memory. These indices are loaded into memory at the initialization of a particular server to allow for rapid completion of queries. The indices and tables may be generated from statistical information gathered from logs of previous cross lingual completion requests so as to pre-rank them using probabilities that map roughly to the popularity of terms queried in the past. In some implementations, a decoder for traversing these tables may take into account the aforementioned context parameters and leverages supervised learning algorithms for producing results that get better over time. That is, the user selection of a particular candidate from a group of candidates is “learned” at a global scale and, by leveraging log data, eventually offers results that may better match users' needs in particular contexts.

At block 804, the server devices 604 receive a query from the client side IME application 610 that includes one or more character corresponding to the contents of a composition window of the client side IME application 610, as well as contextual information such as scenario and n-gram information. The flow then proceeds to block 806.

At block 806, the server devices 604 determine completion candidates based on a language (i.e. the second language) different from that of the one or more characters (i.e. the first language), as well as, depending on the particular implementation, suggested completion candidates in the language of the one or more characters (i.e. the first language). The flow then proceeds to block 808.

At 808, the analysis component 624 selects one or more of the determined completion candidates to be returned to the client device 602 as completion candidates for display in the client side IME application 610 and a ranking order for their presentation using a ranking technique as the technique described above with respect to FIGS. 4 and 5. The selection and ranking may be based on the contextual information included in the query from the client devices 602, as well as the information generated and/or preloaded in block 802. The flow then proceeds to block 810.

At 810, the communication component 626 sends the generated and ranked completion candidates, (if any) to the client device 602, across network 606. Though any number of communication formats could be used for the server response, in some implementations, the server response format is XML. An example XML response is shown below in Table 1 that could be used to return the contents of the candidates window 502 as shown in item 510 of FIG. 5 with the exception that Hanzi characters are also included for English completion candidates in Table 1. Specifically, in Table 1, an R element corresponds to a response. In each R element, there may be one or more C elements that each correspond to a suggested completion candidate. Each C element contains a pair of elements, a completion candidate (T elements) and the Hanzi equivalent (H elements). The C elements are ordered based on the ranking assigned to the candidates. It should be noted that it is possible to have multiple C elements with the same H content, though the T values should be different.

TABLE 1
Example XML Response

| Pinyin | XML Response Example |
|---|---|
| women | <?xml version=″1.0″ encoding=″utf-8″?> |
| | <r> |
| | <c> |
| | <t>women</t> |
| | <h> [symbol] </h> |
| | </c> |
| | <c> |
| | <t>womenswear</t> |
| | <h> [symbol] </h> |
| | </c> |
| | <c> |
| | <t>we</t> |
| | <h> [symbol] </h> |
| | </c> |
| | <c> |
| | <t>our </t> |
| | <h> [symbol] </h> |
| | </c> |
| | </r> |

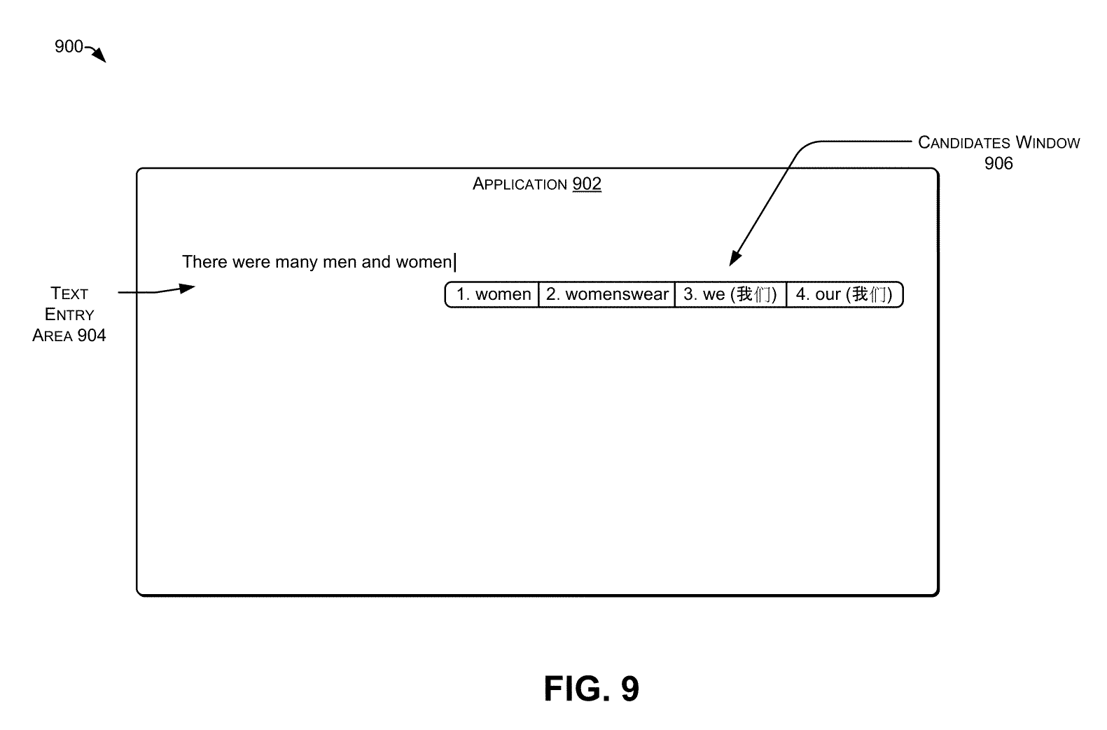

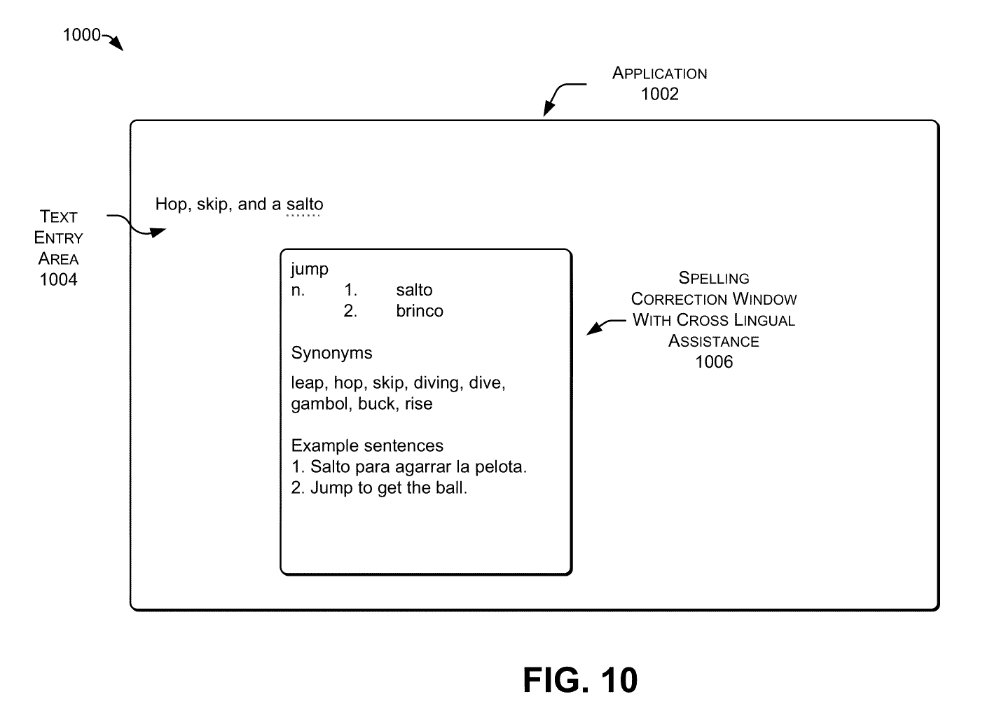

While several examples have been illustrated herein for discussion purposes, numerous other configurations may be used and thus implementations herein are not limited to any particular configuration or arrangement. For example, as previously mentioned, the functionality provided by the disclosed techniques and arrangements are not limited to input method editors. FIGS. 9 and 10 provide examples in which input method editors are absent.

FIG. 9 illustrates an example implementation 900 in which the cross lingual candidate suggestion functionality may be incorporated into an application 902, such as a word processor application with an autocomplete function. As illustrated therein, the application 902 has received the input, “There were many men and women” to the text entry area 904. Here, the cross lingual candidate suggestion functionality of the application 902 operates in a similar manner to that described above for FIG. 5 to provide both same language completion candidates (i.e. “women” and “womenswear”) as well as cross lingual completion candidates (i.e. “we” and “our”). It should be understood that the style of user interface shown in FIG. 9 is not limited to an application with built in cross lingual candidate suggestion functionality. For example, the appearance of the user interface illustrated in could also be applied to a system including a host application and a separate input method editor.

FIG. 10 illustrates an example implementation 1000 in which a cross lingual candidate suggestion functionality may be incorporated into the “spell-checking function” of an application 1002, such as a word processor application. FIG. 10 also illustrates the application of the cross lingual candidate suggestion functionality to a different pair of first and second languages, namely English and Spanish. The application 1002 has received the input, “Hop, skip and a salto” to the text entry area 1004. A spell checking function of the application 1002 determines that the term “salto” is not an English term. However, rather than suggesting English terms such as “salt” to correct an apparent spelling error, the spell checking function uses a cross lingual candidate suggestion functionality to provide suggested translations of the Spanish term “salto” to English. Specifically, the spell checking function suggests correcting the term “salto” to the English term “jump.” Further, the spell checking function may also provide additional information about its suggested correction such as the English language synonyms, “leap, hop, skip, diving, dive, gambol, buck, rise,” and an example sentence written in both Spanish and English. Some implementations may base the determination of whether to provide cross lingual suggestions or normal spelling correction based on settings within the application 1002 or an operating system of the computer executing application 1002. Other implementations may have a learning functionality which may learn that the user of the application 1002 uses both Spanish and English.

The discussion herein refers to data being sent and received by particular components or modules system. This should not be taken as a limitation as such communication need not be direct and the particular components or module need not necessarily be a single functional unit. For example, the statistic analysis and storage component 622 and analysis component 628 are discussed as separate logical components of the system which carry out separate functions and communicate with each other. This is not to be taken as limiting implementations to only those in which the components directly send and receive data from one another. The signals could instead be relayed by a separate component upon receipt of the data. Further, the components may be combined or the functionality may be separated amongst components in various manners not limited to those discussed above. Other variations in the logical and practical structure and framework of various implementations would be apparent to one of ordinary skill in the art in view of the disclosure provided herein.

The processes described herein are only examples provided for discussion purposes. Numerous other variations will be apparent to those of skill in the art in light of the disclosure herein. Further, while the disclosure herein sets forth several examples of suitable frameworks, architectures and environments for executing the techniques and processes herein, implementations herein are not limited to the particular examples shown and discussed. The processes illustrated herein are shown as a collection of operations in a logical flow graph, which represents a sequence of operations, some or all of which can be implemented in hardware, software or a combination thereof. In the context of software, the blocks represent computer-executable instructions stored on one or more computer-readable media that, when executed by one or more processors, perform the recited operations. Generally, computer-executable instructions include routines, programs, objects, components, data structures and the like that perform particular functions or implement particular abstract data types. The order in which the operations are described is not intended to be construed as a limitation. Any number of the described blocks can be combined in any order and/or in parallel to implement the process, and not all of the blocks need be executed.

### Example Computing Device and Environment

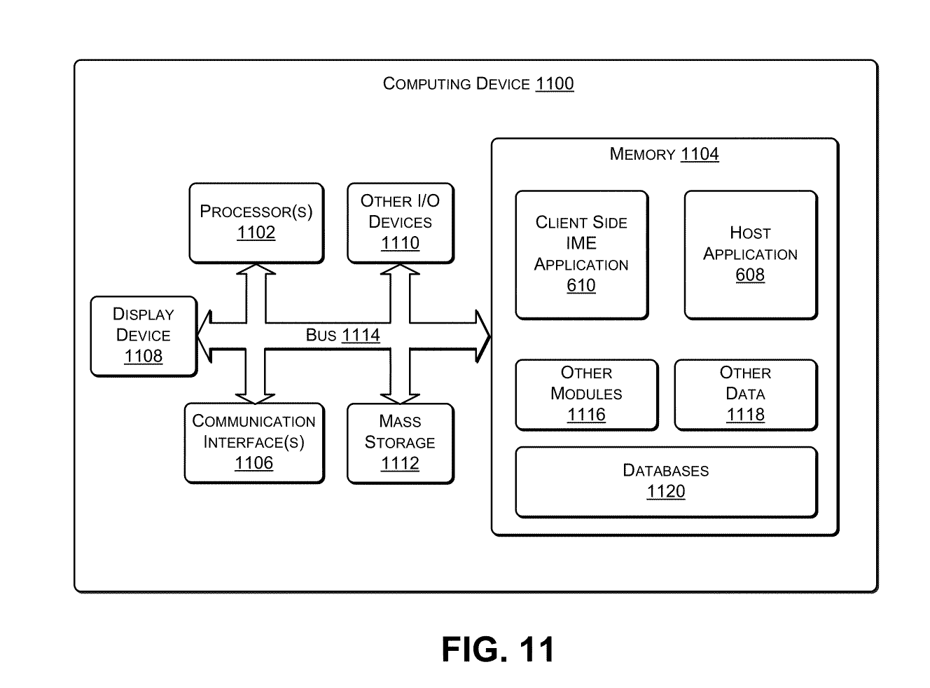

FIG. 11 illustrates an example configuration of a computing device 1100 and an environment that can be used to implement the modules and functions described herein. As shown in FIG. 11, the computing device 1100 corresponds to the client device 602 but it should be understood that the computing device 102 and server devices 604 may be configured in a similar manner to that illustrated.

The computing device 1100 may include at least one processor 1102, a memory 1104, communication interfaces 1106, a display device 1108 (e.g. a touchscreen display), other input/output (I/O) devices 1110 (e.g. a touchscreen display or a mouse and keyboard), and one or more mass storage devices 1112, able to communicate with each other, such as via a system bus 1114 or other suitable connection.

The processor 1102 may be a single processing unit or a number of processing units, all of which may include single or multiple computing units or multiple cores. The processor 1102 can be implemented as one or more microprocessors, microcomputers, microcontrollers, digital signal processors, central processing units, state machines, logic circuitries, and/or any devices that manipulate signals based on operational instructions. Among other capabilities, the processor 1102 can be configured to fetch and execute computer-readable instructions stored in the memory 1104, mass storage devices 1112, or other computer-readable media.

Memory 1104 and mass storage devices 1112 are examples of computer storage media for storing instructions which are executed by the processor 1102 to perform the various functions described above. For example, memory 1104 may generally include both volatile memory and non-volatile memory (e.g., RAM, ROM, or the like). Further, mass storage devices 1112 may generally include hard disk drives, solid-state drives, removable media, including external and removable drives, memory cards, flash memory, floppy disks, optical disks (e.g., CD, DVD), a storage array, a network attached storage, a storage area network, or the like. Both memory 1104 and mass storage devices 1112 may be collectively referred to as memory or computer storage media herein, and may be capable of storing computer-readable, processor-executable program instructions as computer program code that can be executed by the processor 1102 as a particular machine configured for carrying out the operations and functions described in the implementations herein.

The computing device 1100 may also include one or more communication interfaces 1106 for exchanging data with other devices, such as via a network, direct connection, or the like, as discussed above. The communication interfaces 1106 can facilitate communications within a wide variety of networks and protocol types, including wired networks (e.g., LAN, cable, etc.) and wireless networks (e.g., WLAN, cellular, satellite, etc.), the Internet and the like. Communication interfaces 1106 can also provide communication with external storage (not shown), such as in a storage array, network attached storage, storage area network, or the like.

A display device 1108, such as touchscreen display 104 or other display device, may be included in some implementations. Other I/O devices 1110 may be devices that receive various inputs from a user and provide various outputs to the user, and may include a touchscreen, such as touchscreen display 104, a keyboard, a remote controller, a mouse, a printer, audio input/output devices, and so forth.

Memory 1104 may include modules and components for the computing device 1100 according to the implementations discussed herein. In the illustrated example, memory 1104 includes the client side IME application 610 and the host application 608 as described above with regard to FIG. 6. Memory 1104 may further include one or more other modules 1116, such as an operating system, drivers, application software, communication software, or the like. Memory 1104 may also include other data 1118, such as data stored while performing the functions described above and data used by the other modules 1116. Memory 1104 may also include other data and data structures described or alluded to herein. For example, memory 1104 may include information that is used in the course of determining cross lingual completion candidates such as the collocation information for ranking completion candidates as described above.

The example systems and computing devices described herein are merely examples suitable for some implementations and are not intended to suggest any limitation as to the scope of use or functionality of the environments, architectures and frameworks that can implement the processes, components and features described herein. Thus, implementations herein are operational with numerous environments or architectures, and may be implemented in general purpose and special-purpose computing systems, or other devices having processing capability. Generally, any of the functions described with reference to the figures can be implemented using software, hardware (e.g., fixed logic circuitry) or a combination of these implementations. The term “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions) that performs specified tasks or operations when executed on a processing device or devices (e.g., CPUs or processors). The program code can be stored in one or more computer-readable memory devices or other computer storage devices. Thus, the processes, components and modules described herein may be implemented by a computer program product.

Although illustrated in FIG. 11 as being stored in memory 1104 of computing device 1100, the client side IME application 610 and the host application 608, or portions thereof, may be implemented using any form of computer-readable media that is accessible by computing device 1100. As used herein, “computer-readable media” includes, at least, two types of computer-readable media, namely computer storage media and communications media.

Computer storage media includes volatile and non-volatile, removable and non-removable media implemented in any method or technology for storage of information, such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device.

In contrast, communication media may embody computer readable instructions, data structures, program modules, or other data in a modulated data signal, such as a carrier wave, or other transmission mechanism. As defined herein, computer storage media does not include communication media.

Furthermore, this disclosure provides various example implementations, as described and as illustrated in the drawings. However, this disclosure is not limited to the implementations described and illustrated herein, but can extend to other implementations, as would be known or as would become known to those skilled in the art. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation.

### CONCLUSION

Although the subject matter has been described in language specific to structural features and/or methodological acts, the subject matter defined in the appended claims is not limited to the specific features or acts described above. Rather, the specific features and acts described above are disclosed as example forms of implementing the claims. This disclosure is intended to cover any and all adaptations or variations of the disclosed implementations, and the following claims should not be construed to be limited to the specific implementations disclosed in the specification. Instead, the scope of this document is to be determined entirely by the following claims, along with the full range of equivalents to which such claims are entitled.

1. A computing system comprising:
one or more processors;
one or more computer readable media maintaining instructions that, when executed by the one or more processors, cause the one or more processors to perform acts comprising:
displaying a user interface of a host application including a text entry area;
receiving, by an input method editor (IME), one or more characters, the IME to insert a completion candidate of one or more completion candidates into the text entry area of the host application; and
displaying the one or more completion candidates, at least one of the completion candidates being a cross lingual completion candidate in a language different from the one or more characters.

2. The computing system as recited in claim 1, further comprising:
receiving a selection of at least one of the one or more displayed completion candidates; and
inserting the at least one selected completion candidate into the text entry area of the host application.

3. The computing system as recited in claim 1, wherein the displaying the one or more completion candidates includes:
for at least one cross lingual completion candidate, displaying candidate information corresponding to the cross lingual completion candidate, the candidate information including a version of the cross lingual completion candidate in a language different from the cross lingual completion candidate.

4. The computing system as recited in claim 3, wherein the language different from the cross lingual completion candidate is the language of the one or more characters.

5. The computing system as recited in claim 4, wherein the version of the cross lingual completion candidate included in the candidate information is in a different writing system from the one or more characters.

6. The computing system as recited in claim 1, wherein the one or more completion candidates displayed are displayed in an order based on a ranking of the completion candidates.

7. The computing system as recited in claim 6, wherein the ranking of the one or more completion candidates is based at least in part on contextual information about an insertion point at which one or more of the completion candidates are to be inserted.

8. The computing system as recited in claim 1, wherein the displaying the one or more completion candidates includes:
for at least one completion candidate that is in the language of the one or more characters, displaying candidate information corresponding to the completion candidate that is in the language of the one or more characters, the candidate information including a version of the corresponding completion candidate that is in a language different from the completion candidate.

9. A method comprising:
receiving at least part of a term; and
identifying or generating, by a processor, one or more completion candidates, at least one of the completion candidates being in a language different from the term.

10. A method as recited in claim 1, further comprising:
receiving contextual information for the term; and
ranking the one or more completion candidates based, at least in part, on the contextual information.

11. A method as recited in claim 10, wherein the contextual information includes information about an insertion point at which one or more of the completion candidates are to be inserted into a computer application.

12. A method as recited in claim 11, wherein the information about the insertion point includes at least an n-gram and the ranking is based at least in part on collocation.

13. A method as recited in claim 10, wherein the contextual information includes scenario information about a computer application and environment into which the completion candidates are to be inserted.

14. A method as recited in claim 13, wherein the scenario information includes at least one of a process name, an input scope, a version of the computer application, and an operating system.

15. A method as recited in claim 9, further comprising:
ranking the one or more completion candidates, wherein when a plurality of completion candidates are identified or generated, the ranking of at least one completion candidate is based at least in part on whether the completion candidate is in a different language from the term.

16. One or more computer readable media maintaining instructions that, when executed by one or more processors, cause the one or more processors to perform acts comprising:
receiving, by an input method editor (IME), one or more characters, the IME to insert an completion candidate of one or more completion candidates into the text entry area of the host application;
requesting, from a remote service including at least one computing device, one or more completion candidates; and
receiving the one or more completion candidates from the remote service, at least one of the completion candidates being a cross lingual completion candidate in a language different from the one or more characters;
displaying the one or more completion candidates.

17. One or more computer readable media as recited in claim 16, the acts further comprising:
receiving a selection of at least one of the one or more displayed completion candidates; and
inserting the at least one selected completion candidate into the text entry area of the host application.

18. One or more computer readable media as recited in claim 16, the acts further comprising:
determining a number of characters in the one or more characters; and
wherein the requesting is performed when the number of characters in the one or more characters is greater than predefined number.

19. One or more computer readable media as recited in claim 16, the acts further comprising:
prior to the requesting, identifying or generating one or more completion candidates in a same language as the one or more characters;
determining a number of the completion candidates in the same language as the one or more characters; and
wherein the requesting is performed when the number of completion candidates in the same language as the one or more characters is less than predefined number.

20. One or more computer readable media as recited in claim 16, wherein the requesting is performed when a foreign language mode is enabled in one of the IME or the host application.
